(19) United States
(12) Patent Application Publication
(10) Pub. No.: US 2019/0213885 A1
(43) Pub. Date: Jul. 11, 2019

(54) DRIVING ASSISTANCE DEVICE, DRIVING ASSISTANCE METHOD, AND COMPUTER READABLE MEDIUM

(71) Applicant: Mitsubishi Electric Corporation, Tokyo (JP)

(72) Inventors: Takehiko HANADA, Tokyo (JP); Takafumi KASUGA, Tokyo (JP); Michinori YOSHIDA, Tokyo (JP)

(73) Assignee: Mitsubishi Electric Corporation, Tokyo (JP)

(21) Appl. No.: 16/306,025

(22) PCT Filed: Jul. 22, 2016
(86) PCT No.: PCT/JP2016/071576

§ 371 Date: Nov. 30, 2018

(51) Int. Cl. G08G 1/16; B60Q 9/00

(52) U.S. Cl. CPC G08G 1/16; B60Q 9/008

(57) ABSTRACT

A driving assistance device detects an object existing around a mobile body and predicts travel of the detected object. The driving assistance device predicts whether the mobile body and the detected object will collide or not. In case where a collision between the mobile body and the object is predicted, the driving assistance device determines whether notification that the collision has been predicted is to be given to a driver of the mobile body or not, based on whether failure in a prediction of the travel of the object has been detected or not and whether gaze of the driver of the mobile body at the detected object has been determined or not.

### TECHNICAL FIELD

The present invention relates to a technique for notification of a risk of collision between a mobile body and a neighboring object.

### BACKGROUND ART

Half or more of fatal traffic accidents are caused by drowsy driving, unthinking driving, and the like by drivers on vehicle side. Patent Literature 1 discloses calculation of an inter-vehicle distance from time from frontward radiation of a laser beam to return of the reflected beam and alarming on condition that the resultant inter-vehicle distance falls below a standard of a safe inter-vehicle distance found based on a braking distance and a brake reaction distance of a vehicle.

Such alarming, however, may bother the driver depending on a situation of the driver or a content of the alarm. Patent Literature 2 discloses control over a level of an alarm based on a direction and a frequency of gaze of a driver.

### CITATION LIST

### Patent Literature

Patent Literature 1: JP H5-225499

Patent Literature 2: JP H7-167668

### SUMMARY OF INVENTION

### Technical Problem

In case where the level of the alarm is controlled based on the direction and the frequency of the gaze of the driver as disclosed in Patent Literature 2, there is a possibility that a necessary alarm may not be issued to the driver even if a change in the situation necessitates new issuance of an alarm to the driver.

In a specific example, in case where a leading vehicle travelling in front is detected and an alarm is issued based on a prediction about a collision with the leading vehicle, issuance of the alarm is curbed once the driver gazes at the leading vehicle. In case where a change in behavior of the leading vehicle causes a difference between a perception of the driver and a reality, however, the alarm may not be issued afresh or may be delayed.

The present invention mainly aims at appropriate notification on a risk of collision between a mobile body and a neighboring object.

### Solution to Problem

A driving assistance device according to the present invention includes:

a travel prediction unit to predict travel of an object existing around a mobile body;

a failure detection unit to detect failure in a prediction of the travel by the travel prediction unit;

a gaze determination unit to determine whether a driver of the mobile body has gazed at the object or not;

a collision prediction unit to predict a collision between the mobile body and the object based on the prediction of the travel; and

a notification determination unit to determine whether notification that the collision prediction unit has predicted the collision between the mobile body and the object is to be given to the driver or not, based on whether the failure detection unit has detected the failure in the prediction or not and whether the gaze determination unit has determined gaze at the object or not.

### Advantageous Effects of Invention

In the invention, it is determined whether the notification that the collision has been predicted is to be given to the driver or not, in consideration of whether the failure in the prediction has been detected or not. Thus appropriate notification on a risk of collision between the mobile body and a neighboring object may be made.

### BRIEF DESCRIPTION OF DRAWINGS

FIG. 1 is a configuration diagram illustrating a driving assistance device 10 according to Embodiment 1.

FIG. 2 is an illustration of information acquired by a monitoring sensor 31 according to Embodiment 1 and of objects 41 as seen looking from above.

FIG. 3 is an illustration of information acquired by the monitoring sensor 31 according to Embodiment 1 and of the objects 41 as seen looking from a side of a mobile body 100.

FIG. 4 is a flowchart illustrating overall operations of the driving assistance device 10 according to Embodiment 1.

FIG. 5 is a flowchart illustrating an object detection process according to Embodiment 1.

FIG. 6 is an illustration of object information 42 according to Embodiment 1.

FIG. 7 is a configuration diagram illustrating the driving assistance device 10 according to Modification 2.

### DESCRIPTION OF EMBODIMENTS

### Embodiment 1

*** Description on Configurations ***

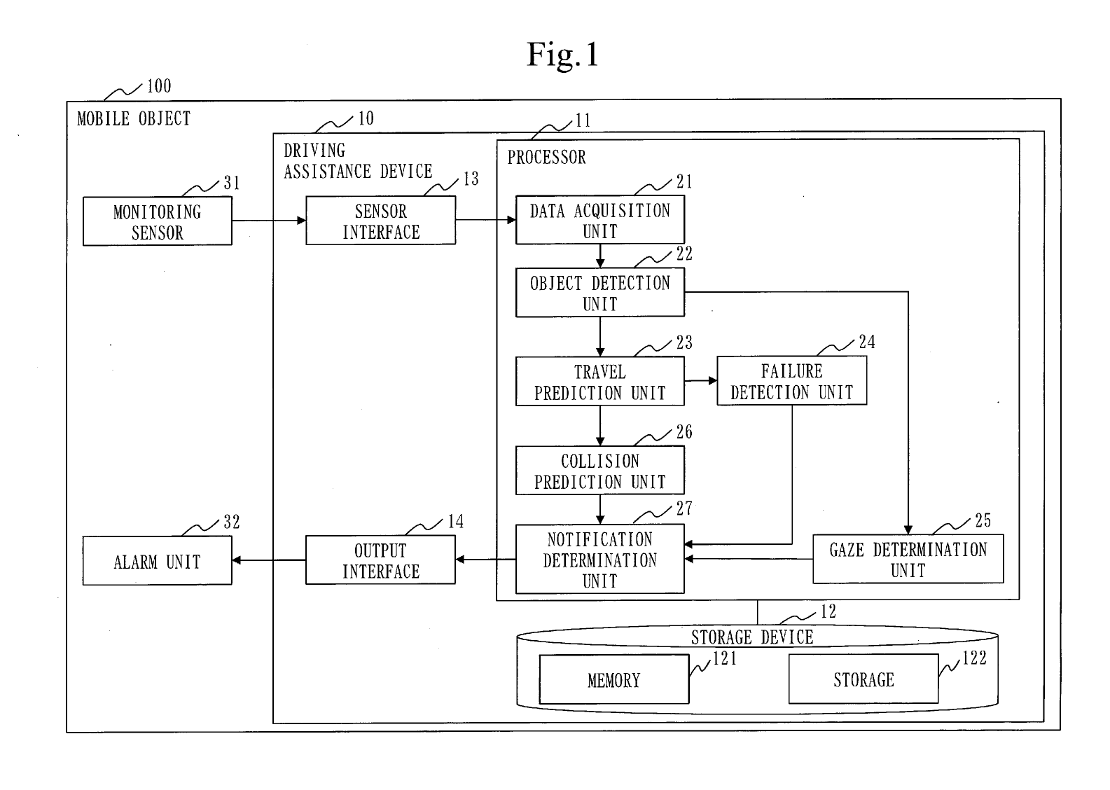

With reference to FIG. 1, a configuration of a driving assistance device 10 according to Embodiment 1 will be described.

The driving assistance device 10 is a computer installed on a mobile body 100. In Embodiment 1, the mobile body 100 is a vehicle. The mobile body 100, however, is not limited to a vehicle and may be another type such as a ship.

The driving assistance device 10 may be implemented in a form integrated with or nondetachable from the mobile body 100 or another illustrated component or may be implemented in a form demountable or detachable from the mobile body 100 or another illustrated component.

The driving assistance device 10 includes a processor 11, a storage device 12, a sensor interface 13, and an output interface 14, as hardware. The processor 11 is connected to other hardware through signal lines in order to control the other hardware.

The processor 11 is an integrated circuit (IC) that carries out processing. The processor 11 is a central processing unit (CPU), a digital signal processor (DSP), or a graphics processing unit (GPU), as a specific example.

The storage device 12 includes a memory 121 and a storage 122. The memory 121 is a random access memory (RAM), as a specific example. The storage 122 is a hard disk drive (HDD), as a specific example. The storage 122 may be a portable storage medium such as a Secure Digital (SD) memory card, a CompactFlash (CF), a NAND flash, a flexible disc, an optical disc, a compact disc, a Blu-ray (a registered trademark) disc, or a digital versatile disk (DVD).

The sensor interface 13 is a device to which sensors such as a monitoring sensor 31 installed on the mobile body 100 are connected. The sensor interface 13 is a connection terminal for Universal Serial Bus (USB), IEEE1394, Controller Area Network (CAN) bus, or Ethernet, as a specific example.

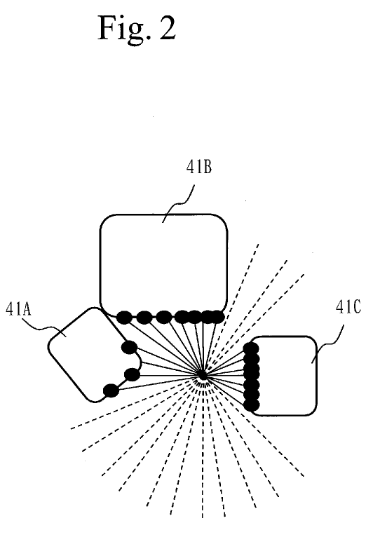

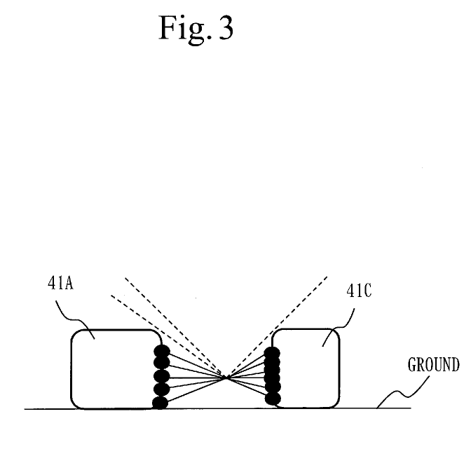

In Embodiment 1, the monitoring sensor 31 is a sensor such as Laser Imaging Detection and Ranging (LIDAR). The LIDAR carries out a process of measuring a distance to an object based on time taken for a laser beam radiated and reflected from the object to return and the speed of light, while rotating horizontally. Thus the LIDAR acquires distance information on the distance to the object located around. In the distance information, a spot on a surface of the object is represented by an azimuth angle and an elevation angle that indicate a direction of radiation of laser and the acquired distance. When objects 41A to 41C are located around the mobile body 100, as illustrated in FIG. 2, the distance information on coordinates represented by black spots as portions of shapes of the objects 41A to 41C is acquired. Depending on a type of the LIDAR, a similar process may be carried out for vertically different angles as illustrated in FIG. 3.

The monitoring sensor 31 may be a millimeter-wave radar. The millimeter-wave radar is a sensor by which a distance to an object is measured based on time taken for a radio wave radiated and reflected from the object to return and the speed of light and by which the distance information on objects in a fan-shaped area centered on the sensor may be acquired. The monitoring sensor 31 may be a stereo camera. Whichever sensor the monitoring sensor 31 is, sensor data made of a list of the distance information may be acquired.

The output interface 14 is a device to which output devices such as an alarm unit 32 installed on the mobile body 100 are connected. The output interface 14 is a connection terminal for USB or High-Definition Multimedia Interface (HDMI; a registered trademark), as a specific example.

The alarm unit 32 is a device that sounds a buzzer or that carries out voice guidance saying “There is a risk of collision with an object”, or the like. The alarm unit 32 may be a device that makes a display using characters or graphics.

The driving assistance device 10 includes a data acquisition unit 21, an object detection unit 22, a travel prediction unit 23, a failure detection unit 24, a gaze determination unit 25, a collision prediction unit 26, and a notification determination unit 27, as functional components. Functions of each of the data acquisition unit 21, the object detection unit 22, the travel prediction unit 23, the failure detection unit 24, the gaze determination unit 25, the collision prediction unit 26, and the notification determination unit 27 are realized by software.

Programs that realize the functions of the units of the driving assistance device 10 are stored in the storage 122 of the storage device 12. The programs are read into the memory 121 by the processor 11 and are executed by the processor 11. Thus the functions of the units of the driving assistance device 10 are realized.

Information, data, signal values, and variable values that indicate results of processes in the functions of the units which are realized by the processor 11 are stored in the memory 121 or a register or a cache memory in the processor 11. In description below, the information, the data, the signal values, and the variable values that indicate the results of the processes in the functions of the units which are realized by the processor 11 will be described as being stored in the memory 121.

The programs that realize the functions that are realized by the processor 11 are assumed to be stored in the storage device 12. The programs, however, may be stored in a portable storage medium such as a magnetic disc, a flexible disc, an optical disc, a compact disc, a Blu-ray (a registered trademark) disc, or a DVD.

In FIG. 1, only one processor 11 is illustrated. The driving assistance device 10, however, may include a plurality of processors that substitute for the processor 11. Execution of the programs that realize the functions of the units of the driving assistance device 10 is divided among the plurality of processors. Each of the processors is an IC that carries out processing as with the processor 11.

*** Description on Operations ***

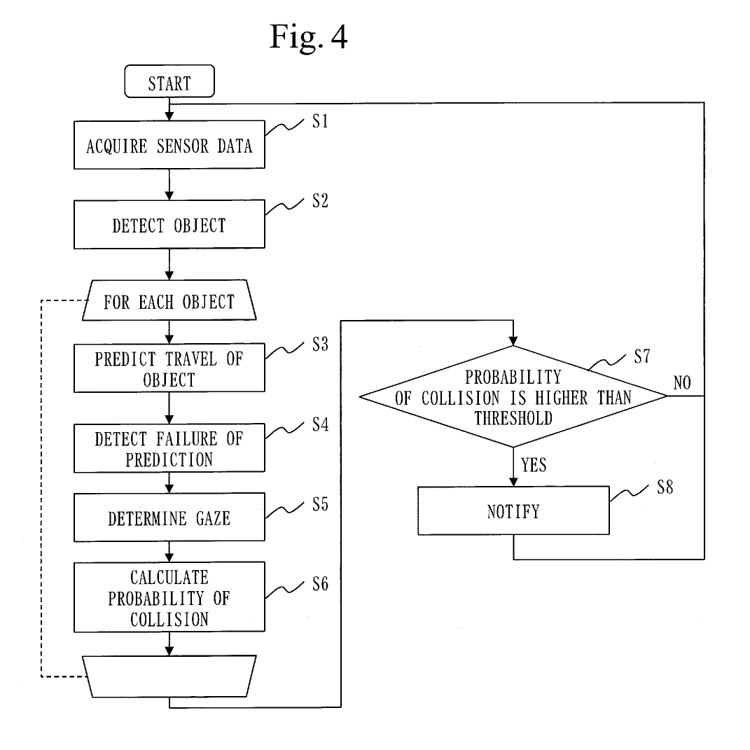

With reference to FIGS. 4 to 6, operations of the driving assistance device 10 according to Embodiment 1 will be described.

The operations of the driving assistance device 10 according to Embodiment 1 correspond to a driving assistance method according to Embodiment 1. The operations of the driving assistance device 10 according to Embodiment 1 also correspond to processes of a driving assistance program according to Embodiment 1.

With reference to FIG. 4, the overall operations of the driving assistance device 10 according to Embodiment 1 will be described.

The driving assistance device 10 periodically carries out the processes illustrated in FIG. 4.

(Step S1: Data Acquisition Process)

The data acquisition unit 21 acquires the sensor data obtained by the monitoring sensor 31, through the sensor interface 13. As described above, the sensor data is made of the list of the distance information that represents the spots on the surfaces of the objects existing around the mobile body 100. The data acquisition unit 21 writes the acquired sensor data into the memory 121.

(Step S2: Object Detection Process)

The object detection unit 22 reads out, from the memory 121, the sensor data acquired in step S1 and detects the objects existing around the mobile body 100, based on the sensor data having been read out.

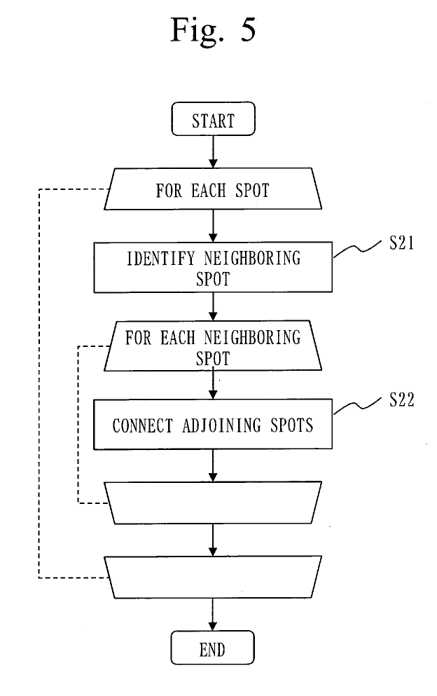

With reference to FIG. 5, object detection processes according to Embodiment 1 will be specifically described.

Processes from step S21 to step S22 are carried out with sequential use of each spot, indicated by the distance information included in the sensor data, as a target spot. In step S21, the object detection unit 22 identifies a spot near to the target spot in the elevation angle and the azimuth angle, as a neighboring spot. The phrase “near in the elevation angle and the azimuth angle” means that the elevation angle is equal to or smaller than a reference elevation angle and that the azimuth angle is equal to or smaller than a reference azimuth angle. Subsequently, the process of step S22 is carried out with use of each neighboring spot identified in step S21, as a target neighboring spot. In step S22, the object detection unit 22 connects a neighboring spot adjoining the target neighboring spot to the target neighboring spot.

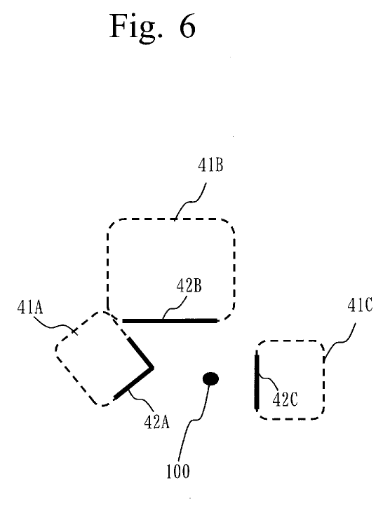

Through the above processes, the spots indicated by the distance information included in the sensor data for each object existing around the mobile body 100 are connected so as to configure a line or a plane as illustrated in FIG. 6. Thus each object existing around the mobile body 100 is identified and an outline and a position of a surface of each object on a side of the mobile body 100 are identified.

The object detection unit 22 writes object information 42 indicating the outline and the approximate position of each object into the memory 121. In an example of FIG. 6, object information 42A to 42C respectively concerned with the objects 41A to 41C is written into the memory 121.

Processes from step S3 to step S6 are carried out with use of each object identified in step S2 and existing around the mobile body 100, as a target object.

(Step S3: Travel Prediction Process)

The travel prediction unit 23 predicts a position of the target object of near future and additionally writes the predicted position into the object information 42 on the target object stored in the memory 121.

In Embodiment 1, the travel prediction unit 23 predicts the position of the target object of the near future with use of a Kalman filter. The travel prediction unit 23 inputs the position of the target object identified in step S2 as an observed value for the Kalman filter into the Kalman filter and determines a resultant prior predicted value of a state as the position of the target object of the future. Along with the position of the target object of the near future, the travel prediction unit 23 then acquires an error covariance matrix that represents a distribution of an existence probability of the target object at each position with respect to the predicted position as a center. It is assumed that information on the Kalman filter is stored in the memory 121 so as to be included in the object information 42 on the target object.

An operation period of the processes illustrated in FIG. 4 is assumed to be F seconds. An integer o is used as an identification number for identification of objects numbering in N. With use of an integer i satisfying 0≤i≤I, predicted positions of an object o from current time k to F·i seconds later are expressed as _{o,i}xₖ and a posterior prediction error matrix is expressed as ₒSₖ.

Then the predicted position _{o,0}xₖ is equal to a state of the Kalman filter, that is, a posterior predicted value ₒxₖ of the position of the object o and the predicted position _{o,1}xₖ is equal to a prior predicted value ₒx⁻ₖ₊₁ at subsequent time (F seconds after the current time k). The predicted positions _{o,i}xₖ for the integer i satisfying 0≤i≤I are calculated by extrapolation based on mutation from the posterior predicted value ₒxₖ to the prior predicted value ₒx⁻ₖ₊₁. That is, a calculation is made as in Formula 1.

_{o,i}xₖ=ₒxₖ+(ₒxₖ₊₁⁻−ₒxₖ)·i [Formula 1]

The travel prediction unit 23 links the object o that had been predicted until previous time k−1 and an object o′ that is detected at the current time k by a method below.

The travel prediction unit 23 uses a position _{o′}x of the object o′ that is detected at the current time k and that has not yet been linked and a probability distribution function _{o,i+1}Pₖ₋₁(x) for the predicted position of each object at the time k predicted at the previous time k−1 and thereby links the object o, which has the highest existence probability _{o,i+1}Pₖ₋₁(_{o′}x) at the position _{o′}x, to the object o′. The travel prediction unit 23 inputs the position _{o′}x of the object o′ as the observed value for the Kalman filter included in the object information 42 on the linked object o and thereby predicts the position of the object o′ of the future. The travel prediction unit 23 writes the information on the Kalman filter included in the object information 42 on the linked object o and the acquired information, as the information on the Kalman filter for the object o′, into the memory 121.

In case where the object o having the existence probability _{o,i+1}Pₖ₋₁(_{o′}x) at the position _{o′}x higher than a reference probability does not exist, the travel prediction unit 23 does not link the object o′ to the object o.

When a plurality of objects o are linked to the single object o′, the position of the object o′ of the future is predicted by input of the position _{o′}x as the observed value for the Kalman filter for each object o. When the single object o is linked to a plurality of objects o′, the object information 42 on the object o is duplicated on an assumption that the object o has split up and the position of each object o′ of the future is predicted by input of each position _{o′}x into the Kalman filter for each piece of object information 42. As for the object o′ that is not linked to the object o, it is assumed that the object has newly appeared and the position of the object o′ of the future is predicted with provision of new object information 42 including the Kalman filter having _{o′}x as an initial value. As for the object o that is not linked to any object _{o′}, it is assumed that the object o has disappeared and the object information 42 on the object o is discarded.

Without limitation to the prediction process with use of the Kalman filter, the travel prediction unit 23 may calculate the existence probability of the target object at each position of the target object through another prediction process.

(Step S4: Failure Detection Process)

The failure detection unit 24 detects failure in a prediction of travel by the travel prediction unit 23.

In Embodiment 1, the failure detection unit 24 detects failure in a result predicted at the previous time in step S3. Herein, the predicted position _{o,j}xₖ acquired in step S3 at the time k and the predicted position _{o,(j+1)}xₖ₋₁ acquired in step S3 at the previous time k−1 both include a predicted position at time k+j for each integer j satisfying 0≤j≤I−1, though the time of the prediction differs. The failure detection unit 24 detects the failure in the prediction in case where a Euclidean distance between the predicted position _{o,j}xₖ and the predicted position _{o,(j+1)}xₖ₋₁ exceeds a threshold. Alternatively, the failure detection unit 24 may detect the failure in the prediction in case where a Mahalanobis' generalized distance calculated with use of a posterior or prior covariance matrix of the predicted position _{o,j}xₖ and the predicted position _{o,(j+1)}xₖ₋₁ exceeds a threshold.

The failure detection unit 24 additionally writes failure information indicating whether the failure in the prediction has been detected or not, into the object information 42 on the target object. Instead of permanent storage of the failure information, a ring buffer that retains latest past pieces of the failure information numbering in h may be configured in the object information 42. Here, h is an arbitrary positive integer.

(Step S5: Gaze Determination Process)

The gaze determination unit 25 determines whether a driver of the mobile body 100 has gazed at the target object or not.

In Embodiment 1, the gaze determination unit 25 determines whether the driver has gazed at the target object or not, by identification of a view vector of the driver and by collision determination with the target object. Specifically, the gaze determination unit 25 determines presence or absence of a geometrical intersection of the identified view vector and the line or the plane configured by connection of the spots indicated by the distance information on the target object in step S22. The view vector may be identified by detection of an orientation of a face with use of a camera mounted in a vehicle and detection of an orientation of eyes with use of camera-equipped glasses. A sensor and an algorithm for identification of the view vector may be of any type.

The gaze determination unit 25 additionally writes a gaze determination result as to whether the driver has gazed at the target object or not, into the object information 42 on the target object. Instead of permanent storage of the gaze determination result, a ring buffer that retains the gaze determination results of latest past numbering in h may be configured in the object information 42.

In Embodiment 1, the gaze determination unit 25 determines that the driver has gazed at the target object, in case where a number of results with presence of gaze after time of latest failure in the prediction among the results of the latest past numbering in h exceeds H that is a threshold. The gaze determination unit 25 provides a gaze flag in the object information 42 and, in case where it is determined that the driver has gazed at the target object, sets a value of 1 indicating the presence of the gaze in the gaze flag. On the other hand, in case where the gaze is not determined, the gaze determination unit 25 sets a value of 0 indicating absence of the gaze in the gaze flag. Thus the failure in the prediction causes unsetting of the gaze flag for the target object even if the driver has gazed at the target object. In Embodiment 1, a premise that the gaze at the target object is determined in case where the gaze has been focused on the target object for F·H seconds or longer in total within F·h seconds of the latest past is made and the values of h and H are determined from the premise.

(Step S6: Collision Prediction Process)

The collision prediction unit 26 calculates a probability of collision between the mobile body 100 and the target object. In Embodiment 1, the collision prediction unit 26 calculates a probability that the target object will exist at a position of the mobile body 100 at a time point of future, as the probability of collision between the mobile body 100 and the target object.

As a premise, it is assumed that the position of the mobile body 100 of near future is predicted. The position of the mobile body 100 of the near future may be predicted with use of the Kalman filter as with the process of predicting the position of the target object of the near future in step S3. The position of the mobile body 100 of the near future may be predicted by a method different from a method for the position of the target object of the near future, in consideration of other types of information such as velocity information, acceleration information, and steering angle information on the mobile body 100.

At time k, a probability ₒPₖ(x) that the object o will exist at a position x, F·i seconds after the time k is expressed by Formula 2.

$${ }_{o , i} {P}_{k} ( x ) = \frac{1}{2 π \sqrt{{\vert}_{o} {S}_{k} \vert}} exp ( - \frac{1}{2} {{( x {-}_{o , i} {x}_{k} )}^{T}}_{o} {S}_{k}^{- 1} ( x {-}_{o , i} {x}_{k} ) ) \qquad [ Formula 2 ]$$

Provided that a predicted position of the mobile body 100 at F·i seconds after the time k is expressed as ᵢx\hat{ }ₖ, a probability that the mobile body 100 and the object o will be at the same position, that is, the probability of collision between the mobile body 100 and the object o is expressed as a probability _{o,i}Pₖ(ᵢx\hat{ }ₖ).

(Step S7: Notification Determination Process)

The notification determination unit 27 uses only an object, having the value of 0 set in the gaze flag in step S5, as an object of determination and determines whether the probability ᵢP^{˜}ₖ(ᵢx\hat{ }ₖ) of collision between the mobile body 100 and the object of determination is higher than a reference value ᵢT or not. The notification determination unit 27 advances the processes to step S8 in case where the probability ᵢP^{˜}ₖ(ᵢx\hat{ }ₖ) of collision is higher than the reference value ᵢT or returns the processes to step S1 otherwise.

In Embodiment 1, the probability _{o,i}P^{˜}ₖ(ᵢx\hat{ }ₖ) of collision between the mobile body 100 and the object of determination is expressed as in Formula 3. In Formula 3, the probability of collision for the object having the value of 1 set in the gaze flag is made zero in order that only the objects having the value of 0 set in the gaze flag may be used as the objects of determination.

$${ }_{o , i} {P}_{k}^{\sim} ( {}_{i}^{}{x}{}_{k}^{⋀} ) = \{ \begin{matrix}0 & ( Gaze flag 1 ) \\ { }_{o , i} {P}_{k} ( {}_{i}^{}{x}{}_{k}^{⋀} ) & ( Gaze flag 0 )\end{matrix} \qquad [ Formula 3 ]$$

The probability ᵢP^{˜}ₖ(ᵢx\hat{ }ₖ) of collision between the mobile body 100 and all the objects having the value of 0 set in the gaze flag is expressed as Formula 4.

$${}_{i}^{}{P}{}_{k}^{\sim} ( x ) = 1 - {\prod }_{o = 1}^{N} ( 1 - {}_{o , i}^{}{P}{}_{k}^{\sim} ( x ) ) \qquad [ Formula 4 ]$$

On condition that the notification is made in case where the probability of collision exceeds a given value irrespective of the integer i for identification of time having elapsed from the time k, the given value is set as the reference value ᵢT. As a specific example, on condition that the notification is made in case where the probability of collision exceeds 50% irrespective of the integer i, the reference value ᵢT is 0.5. On condition that the notification is made in case where the probability of collision gradually increases, the reference value ᵢT is set so that ᵢ₁T<ᵢ₂T may hold for i1<i2.

In other words, the notification determination unit 27 determines whether notification that the collision prediction unit 26 has predicted a collision between the mobile body 100 and the object is to be given to the driver or not, based on time when the failure detection unit 24 detected the failure in the prediction and time when the gaze determination unit 25 determined the gaze at the object. Specifically, the notification determination unit 27 determines that the notification is not to be given in case where the time when the gaze determination unit 25 determined the gaze at the object was posterior to the time when the failure detection unit 24 detected the failure in the prediction. On the other hand, the notification determination unit 27 determines that the notification is to be given in case where the time when the gaze determination unit 25 determined the gaze at the object was prior to the time when the failure detection unit 24 detected the failure in the prediction.

The notification determination unit 27 advances the processes to step S8 upon a determination that the notification is to be given, or returns the processes to step S1 otherwise.

(Step S8: Notification Process)

The notification determination unit 27 outputs instruction information for instruction for the notification, through the output interface 14 to the alarm unit 32. Then the alarm unit 32 issues an alarm by a method such as sounding a buzzer or carrying out voice guidance and thereby notifies the driver that a collision between the mobile body 100 and an object existing around the mobile body 100 has been predicted. The alarm unit 32 may issue the alarm using characters or graphics.

### Effects of Embodiment 1

As described above, the driving assistance device 10 according to Embodiment 1 determines whether the notification that the collision has been predicted is to be given to the driver or not, in consideration of whether the failure in the prediction has been detected or not. More specifically, the driving assistance device 10 includes an object which has been already gazed at so as to be recognized by the driver and for which the travel prediction has failed, in the targets, and then determines whether the notification is to be given to the driver or not. Thus the appropriate notification on a risk of collision between the mobile body and a neighboring object may be made.

*** Other Configurations ***

<Modification 1>

In Embodiment 1, whether the notification is to be given or not is determined with use of the probability ᵢP^{˜}ₖ(ᵢx\hat{ }ₖ) of collision with all the objects having the value of 0 set in the gaze flag in step S7. As Modification 1, however, whether the notification is to be given or not may be determined with use of the probability _{o,i}P^{˜}ₖ(ᵢx\hat{ }ₖ) of collision with each object having the value of 0 set in the gaze flag in step S7.

That is, the notification determination unit 27 may determine whether the probability _{o,i}P^{˜}ₖ(ᵢx\hat{ }ₖ) of collision is higher than the reference value T or not for each object having the value of 0 set in the gaze flag and may determine that the notification is to be given in case where at least one probability _{o,i}P^{˜}ₖ(ᵢx\hat{ }ₖ) of collision is higher than the reference value ᵢT. That is, the notification determination unit 27 determines that the notification is not to be given to the driver for an object for which the gaze is determined by the gaze determination unit 25 after detection of the failure in the prediction by the failure detection unit 24 and determines that the notification is to be given to the driver for an object for which the gaze is determined by the gaze determination unit 25 only before the detection of the failure in the prediction by the failure detection unit 24.

<Modification 2>

In Embodiment 1, the functions of the units of the driving assistance device 10 are realized by software. As Modification 2, the functions of the units of the driving assistance device 10 may be realized by hardware. Differences from Embodiment 1 in Modification 2 will be described.

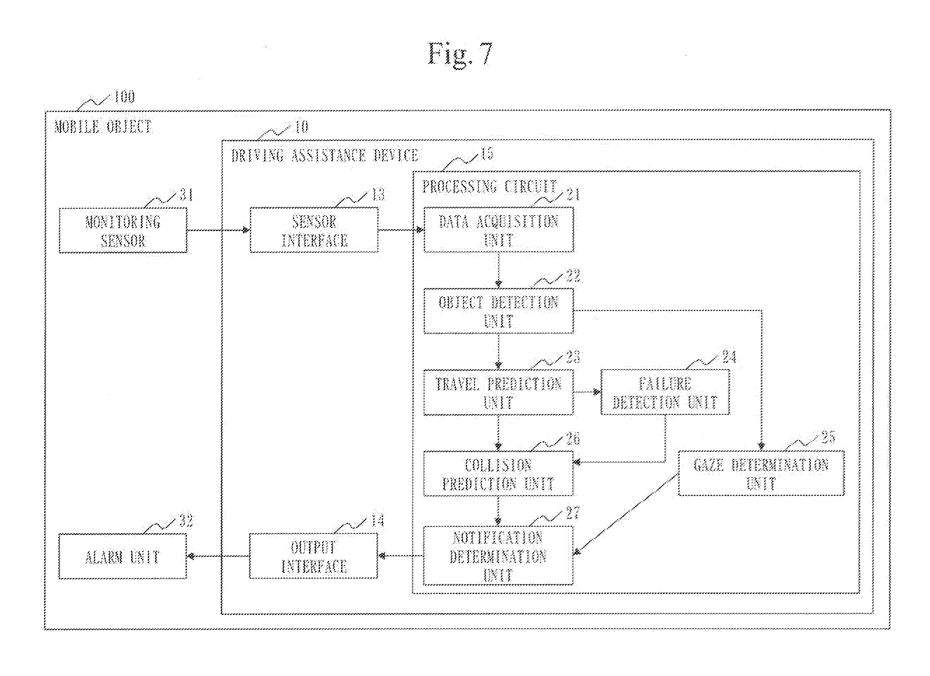

With reference to FIG. 7, a configuration of the driving assistance device 10 according to Modification 2 will be described.

In case where the functions of the units are realized by hardware, the driving assistance device 10 includes a processing circuit 15 in place of the processor 11 and the storage device 12. The processing circuit 15 is a dedicated electronic circuit that fulfils the functions of the units of the driving assistance device 10 and functions of the storage device 12.

As the processing circuit 15, a single circuit, a composite circuit, a programmed processor, a parallelly programmed processor, a logic IC, a gate array (GA), an application specific integrated circuit (ASIC), or a field-programmable gate array (FPGA) may be assumed.

The functions of the units may be realized by one processing circuit 15 or may be distributed among and realized by a plurality of processing circuits 15.

<Modification 3>

As Modification 3, some of the functions may be realized by hardware and the others of the functions may be realized by software. That is, some of the functions of the units of the driving assistance device 10 may be realized by hardware and the others of the functions of the units may be realized by software.

The processor 11, the storage device 12, and the processing circuit 15 are collectively referred to as “processing circuitry”. That is, the functions of the units are realized by the processing circuitry.

### REFERENCE SIGNS LIST

10: driving assistance device; 11: processor; 12: storage device; 121: memory; 122: storage; 13: sensor interface; 14: output interface; 15: processing circuit; 21: data acquisition unit; 22: object detection unit; 23: travel prediction unit; 24: failure detection unit; 25: gaze determination unit; 26: collision prediction unit; 27: notification determination unit; 31: monitoring sensor; 32: alarm unit; 41: object; 42: object information

1-8. (canceled)

9. A driving assistance device comprising:
processing circuitry to:
predict travel of an object existing around a mobile body;
detect failure in a prediction of the travel when a distance between a position of the object at time k+j predicted at time k and a position of the object at the time k+j predicted at time k′ different from the time k exceeds a threshold;
determine whether a driver of the mobile body has gazed at the object or not;
predict a collision between the mobile body and the object based on the prediction of the travel; and
determine whether notification that the collision between the mobile body and the object has been predicted is to be given to the driver or not, based on whether the failure in the prediction has been detected or not and whether gaze at the object has been determined or not.

10. The driving assistance device according to claim 9, wherein
the processing circuitry determines whether the notification is to be given or not, based on time when the failure in the prediction has been detected and time when the gaze at the object has been determined.

11. The driving assistance device according to claim 10, wherein
the processing circuitry determines that the notification is not to be given, in case where the time when the gaze at the object has been determined is posterior to the time when the failure in the prediction has been detected.

12. The driving assistance device according to claim 10, wherein
the processing circuitry determines that the notification is to be given, in case where the time when the gaze at the object has been determined is prior to the time when the failure in the prediction has been detected.

13. The driving assistance device according to claim 11, wherein
the processing circuitry determines that the notification is to be given, in case where the time when the gaze at the object has been determined is prior to the time when the failure in the prediction has been detected.

14. The driving assistance device according to claim 9, wherein
the distance is a Euclidean distance.

15. The driving assistance device according to claim 10, wherein
the distance is a Euclidean distance.

16. The driving assistance device according to claim 11, wherein
the distance is a Euclidean distance.

17. The driving assistance device according to claim 12, wherein
the distance is a Euclidean distance.

18. The driving assistance device according to claim 13, wherein
the distance is a Euclidean distance.

19. The driving assistance device according to claim 9, wherein
the distance is a Mahalanobis' generalized distance.

20. The driving assistance device according to claim 10, wherein
the distance is a Mahalanobis' generalized distance.

21. The driving assistance device according to claim 11, wherein
the distance is a Mahalanobis' generalized distance.

22. The driving assistance device according to claim 12, wherein
the distance is a Mahalanobis' generalized distance.

23. The driving assistance device according to claim 13, wherein
the distance is a Mahalanobis' generalized distance.

24. A driving assistance method comprising:
predicting travel of an object existing around a mobile body;
detecting failure in a prediction of the travel when a distance between a position of the object at time k+j predicted at time k and a position of the object at the time k+j predicted at time k′ different from the time k exceeds a threshold;
determining whether a driver of the mobile body has gazed at the object or not;
predicting a collision between the mobile body and the object based on the prediction of the travel; and
determining whether notification that the collision between the mobile body and the object has been predicted is to be given to the driver or not, based on whether the failure in the prediction of the travel has been detected or not and whether gaze at the object has been determined or not.

25. A non-transitory computer readable medium storing a driving assistance program that causes a computer to execute:
a travel prediction process of predicting travel of an object existing around a mobile body;
a failure detection process of detecting failure in a prediction of the travel in the travel prediction process when a distance between a position of the object at time k+j predicted by the travel prediction process at time k and a position of the object at the time k+j predicted by the travel prediction process at time k′ different from the time k exceeds a threshold;
a gaze determination process of determining whether a driver of the mobile body has gazed at the object or not;
a collision prediction process of predicting a collision between the mobile body and the object based on the prediction of the travel; and
a notification determination process of determining whether notification that the collision between the mobile body and the object has been predicted in the collision prediction process is to be given to the driver or not, based on whether the failure in the prediction has been detected in the failure detection process or not and whether gaze at the object has been determined in the gaze determination process or not.

26. A driving assistance device comprising:
processing circuitry to:
predict travel of an object existing around a mobile body;
detect failure in a prediction of the travel;
determine whether a driver of the mobile body has gazed at the object or not;
predict a collision between the mobile body and the object based on the prediction of the travel; and
determine whether notification that the collision between the mobile body and the object has been predicted is to be given to the driver or not, based on time when the failure in the prediction has been detected and time when gaze at the object has been determined.
